(19) United States
(12) Patent Application Publication
(10) Pub. No.: US 2026/0166853 A1
(43) Pub. Date: Jun. 18, 2026

(54) METAL MATRIX COMPOSITE TAPE WITH SEALED FIBER ENDS

(71) Applicant: Touchstone Research Laboratory, Ltd., Triadelphia, WV (US)

(72) Inventors: Brian E. Joseph, Triadelphia, WV (US); Brandon J. Coates, Shadyside, OH (US); Brian L. Gordon, Wheeling, WV (US)

(21) Appl. No.: 18/979,774

(22) Filed: Dec. 13, 2024

(51) Int. Cl. B32B 15/04; B32B 3/26; B32B 15/20

(52) U.S. Cl. CPC B32B 15/04; B32B 3/266; B32B 15/20; B32B 2255/06; B32B 2255/205; B32B 2262/105; B32B 2307/7376

(57) ABSTRACT

A metal matrix composite (MMC) tape includes a plurality of reinforcing fibers embedded within a metal matrix, at least one exposed surface where ends of the reinforcing fibers are exposed, and a coating applied to the at least one exposed surface. The coating seals the exposed ends of the reinforcing fibers. The coating may be applied to at least one end of the MMC tape or to an interior surface of a hole formed through the MMC tape. The metal matrix may comprise aluminum and the reinforcing fibers may comprise alumina fibers. The coating may be applied using plasma vapor deposition, spray coating, or chemical vapor deposition. A method of preparing the MMC tape and a composite structure incorporating the MMC tape are also provided.

### TECHNICAL FIELD

The present disclosure relates to metal matrix composite materials, and more particularly to a metal matrix composite tape with sealed fiber ends and methods for sealing exposed fibers in such materials.

### BACKGROUND

Metal matrix composite (MMC) materials have gained significant attention in various industries due to their unique combination of properties, including high strength-to-weight ratio, excellent thermal conductivity, and improved wear resistance. These materials typically consist of a metal matrix reinforced with high-strength fibers, such as carbon, ceramic, or metal fibers. While MMC materials offer numerous advantages, they present challenges in manufacturing and processing, particularly when cutting, drilling, or machining is required. These operations often result in exposed fiber ends at cut surfaces or within drilled holes, which can lead to issues such as fiber degradation, potential contamination, and reduced structural integrity in certain applications.

The exposed fibers in MMC materials can be particularly problematic in environments where the material may be subjected to chemical reactions, high temperatures, or mechanical stresses. Additionally, in precision applications, the presence of exposed fibers can interfere with the desired surface finish or dimensional accuracy of the component. As the use of MMC materials continues to expand into more diverse and demanding applications, there is a growing need for effective methods to address the challenges posed by exposed fibers and to enhance the overall performance and reliability of MMC components.

There is a need for effective methods to seal exposed fibers and fiber ends in metal matrix composite materials, particularly when cutting, drilling, or machining operations are required, in order to prevent fiber degradation, contamination, and reduced structural integrity in demanding applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a metal matrix composite (MMC) tape is provided. The MMC tape includes a plurality of reinforcing fibers embedded within a metal matrix. The MMC tape includes at least one exposed surface where ends of the reinforcing fibers are exposed. A coating is applied to the at least one exposed surface, wherein the coating seals the exposed ends of the reinforcing fibers.

According to other aspects of the present disclosure, the MMC tape may include one or more of the following features. The coating may be applied to at least one end of the MMC tape, sealing exposed ends of the reinforcing fibers at the at least one end. The MMC tape may further comprise a hole formed through the MMC tape, wherein the coating is applied to an interior surface of the hole to seal exposed ends of the reinforcing fibers within the hole. The metal matrix may comprise aluminum and the reinforcing fibers may comprise alumina fibers. The metal matrix may comprise at least one of aluminum, magnesium, titanium, copper, or alloys thereof, and the reinforcing fibers may comprise at least one of alumina, boron, silicon carbide, carbon, or glass fibers. The coating may comprise at least one of a metal, a metal alloy, a ceramic, or a polymer material. The MMC tape may have a thickness between about 0.01 inches and about 0.03 inches.

According to another aspect of the present disclosure, a method of preparing a metal matrix composite (MMC) tape is provided. The method includes providing an MMC tape comprising a plurality of reinforcing fibers embedded within a metal matrix. The method includes forming at least one exposed surface on the MMC tape where ends of the reinforcing fibers are exposed. The method includes applying a coating to the at least one exposed surface, wherein the coating seals the exposed ends of the reinforcing fibers.

According to other aspects of the present disclosure, the method may include one or more of the following features. The forming step may comprise cutting an end of the MMC tape. The forming step may comprise creating a hole through the MMC tape. Applying the coating may comprise using at least one of plasma vapor deposition, chemical vapor deposition (CVD), or spray coating techniques such as thermal spray, arc spray, high velocity oxygen fuel (HVOF) spray, powder coating or other spray coating techniques. Applying the coating using chemical vapor deposition (CVD) may comprise placing the MMC tape in a CVD chamber, introducing one or more precursor gases into the CVD chamber, heating the CVD chamber to a deposition temperature, maintaining the deposition temperature for a predetermined time to allow the precursor gases to react and form the coating on the at least one exposed surface, and cooling the CVD chamber and removing the coated MMC tape. Applying the coating using plasma vapor deposition may comprise placing the MMC tape in a plasma vapor deposition chamber, introducing a process gas into the plasma vapor deposition chamber, generating a plasma from the process gas, introducing a coating material into the plasma, directing the plasma containing the coating material towards the at least one exposed surface of the MMC tape, and maintaining the plasma vapor deposition process for a predetermined time to form the coating on the at least one exposed surface. Applying the coating using spray coating may comprise placing the MMC tape in a spray coating chamber or positioning it in front of a spray coating nozzle, introducing a carrier gas into a spray coating system, heating the carrier gas to a temperature between about 100° C. to 1000° C., introducing coating material in the form of fine powder particles into the heated carrier gas stream, accelerating the mixture of heated carrier gas and powder particles through a de Laval nozzle to supersonic speeds, directing the accelerated powder particles towards the at least one exposed surface of the MMC tape, and maintaining the spray coating process for a predetermined time to form the coating on the at least one exposed surface.

The metal matrix may comprise at least one of aluminum, magnesium, titanium, copper, or alloys thereof, the reinforcing fibers may comprise at least one of alumina, boron, silicon carbide, carbon, or glass fibers, and the coating may comprise at least one of a metal, a metal alloy, a ceramic, or a polymer material. The metal matrix may comprise aluminum, the reinforcing fibers may comprise alumina fibers, and the coating may comprise aluminum. The forming step may comprise creating an oversized hole through the MMC tape, applying the coating to an interior surface of the oversized hole with a coating thickness sufficient to create a hole diameter smaller than a desired final diameter, and machining the coated hole to the desired final diameter.

According to another aspect of the present disclosure, a composite structure is provided. The composite structure includes a metal core, a first metal matrix composite (MMC) layer disposed on a first side of the metal core, and a second metal matrix composite (MMC) layer disposed on a second side of the metal core opposite the first side. The composite structure includes at least one hole extending through the first MMC layer, the metal core, and the second MMC layer. A coating is applied to an interior surface of the at least one hole, wherein the coating extends continuously through the first MMC layer and the second MMC layer wherein the coating seals the exposed ends of the reinforcing fibers in the at least one hole in the first MMC layer and the second MMC layer.

According to other aspects of the present disclosure, the composite structure may include one or more of the following features. The first and second MMC layers may comprise a metal matrix of at least one of aluminum, magnesium, titanium, copper, or alloys thereof, and reinforcing fibers of at least one of alumina, boron, silicon carbide, carbon, or glass fibers. The metal core may comprise at least one of aluminum, titanium, steel, or alloys thereof. The coating may comprise at least one of a metal, a metal alloy, a ceramic, or a polymer material. The first and second MMC layers may comprise a metal matrix of aluminum and reinforcing fibers of alumina. The metal core may comprise aluminum. The coating may comprise aluminum. Each of the first MMC layer and the second MMC layer may comprise two or more layers of MMC tape oriented at different angles relative to each other. The two or more layers of MMC tape in each of the first MMC layer and the second MMC layer may be oriented at 90 degrees relative to each other.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a perspective view of a metal matrix composite tape, according to aspects of the present disclosure.

FIG. 2 illustrates a perspective view of a metal matrix composite tape with an end coating, according to an embodiment.

FIG. 3 illustrates a perspective view of a metal matrix composite tape with a hole, according to aspects of the present disclosure.

FIG. 4 illustrates a cross-sectional view of a metal matrix composite tape with a hole, according to an embodiment.

FIG. 5 illustrates a section view of a metal matrix composite tape with a coated hole, according to aspects of the present disclosure.

FIG. 6 illustrates a cross-sectional view of a metal matrix composite tape with a machined coated hole, according to an embodiment.

FIG. 7 illustrates a perspective view of a metal matrix composite tape with a coated hole, according to aspects of the present disclosure.

FIG. 8 illustrates an isometric view of a composite structure with coated holes, according to an embodiment.

FIG. 9 illustrates a flowchart for a method of preparing and coating metal matrix composite tape, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a metal matrix composite (MMC) tape with sealed fiber ends. The MMC tape comprises a plurality of reinforcing fibers embedded within a metal matrix. The reinforcing fibers may include, but are not limited to, carbon fibers, boron fibers, silicon carbide fibers, aluminum oxide fibers, glass fibers, quartz fibers, basalt fibers, ceramic fibers, metal fibers, or combinations thereof. The metal matrix may include, but is not limited to, aluminum, magnesium, silver, gold, platinum, copper, palladium, zinc, including alloys and combinations thereof.

In some aspects, the MMC tape may have at least one exposed surface where ends of the reinforcing fibers are exposed. To prevent fiber degradation, contamination, and reduced structural integrity in demanding applications, a coating is applied to the at least one exposed surface. The coating effectively seals the exposed ends of the reinforcing fibers, providing protection against environmental factors and improving the overall performance of the MMC tape in sensitive applications.

The coating may be applied using various techniques such as plasma vapor deposition or chemical vapor deposition (CVD), offering precise control over the coating thickness and composition. In some cases, the coating material may be similar or compatible with the metal matrix of the MMC tape.

In certain embodiments, the MMC tape may include a hole formed through the MMC tape, wherein the coating is applied to an interior surface of the hole to seal exposed ends of the reinforcing fibers within the hole. This approach ensures complete coverage of all exposed fibers while allowing for subsequent refinement of the hole size.

The present disclosure also provides methods for preparing the MMC tape and applying the coating to the exposed fiber ends. These methods may include forming at least one exposed surface on the MMC tape where ends of the reinforcing fibers are exposed, and applying a coating to the at least one exposed surface to seal the exposed ends of the reinforcing fibers.

The MMC tape with sealed fiber ends, as described herein, may be beneficial for a variety of applications, particularly in industries where high strength-to-weight ratio, excellent thermal conductivity, and improved wear resistance are crucial.

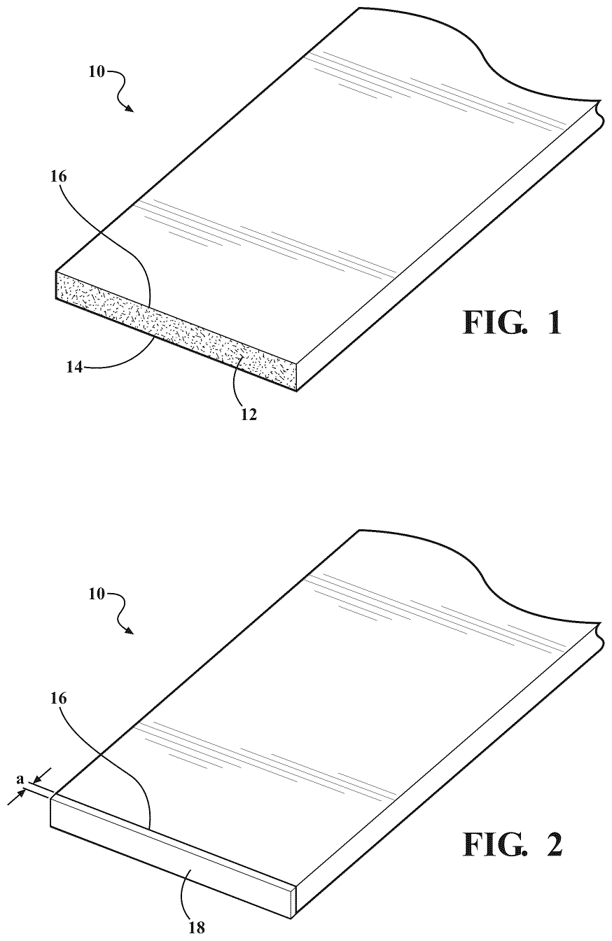

Referring to FIG. 1, a perspective view of a metal matrix composite (MMC) tape 10 is illustrated. The MMC tape 10 comprises a plurality of reinforcing fibers 12 embedded within a metal matrix 14. The reinforcing fibers 12 are shown as elongated structures running along the length of the MMC tape 10. The metal matrix 14 surrounds and encapsulates the reinforcing fibers 12, providing structural support and cohesion to the composite material.

In some aspects, the metal matrix 14 may comprise aluminum and the reinforcing fibers 12 may comprise alumina fibers. In other cases, the metal matrix 14 may comprise at least one of aluminum, magnesium, titanium, copper, or alloys thereof, and the reinforcing fibers 12 may comprise at least one of alumina, boron, silicon carbide, carbon, or glass fibers.

The MMC tape 10 has a tape end 16 with exposed ends or portions of the reinforcing fibers 12. The tape end 16 shows the internal composition of reinforcing fibers 12 within the metal matrix 14. The MMC tape 10 is shown as a rectangular strip with a defined thickness. In some embodiments, the MMC tape 10 may have a thickness between about 0.01 inches and about 0.03 inches. The width is not particularly limited but may range from about 0.25 inches to about 6 inches. The length of the MMC tape 10 may be determined based on the requirements of the application, and the MMC tape 10 may be cut to the desired length or shape.

In some embodiments, the MMC tape 10 may be provided as a roll or coil of continuous tape, which can be cut to the desired length as needed. This flexibility in length allows the MMC tape 10 to be tailored for a wide range of applications, from small components to large structures.

Referring to FIG. 2, a perspective view of a metal matrix composite (MMC) tape 10 with an end coating 18 is illustrated. The MMC tape 10 is shown as an elongated structure with a rectangular cross-section. At one end of the MMC tape 10 is the tape end 16, which is covered by the end coating 18. The end coating 18 is depicted as a layer of material applied to the tape end 16 having a thickness “a” and extending slightly beyond the edges of the MMC tape 10. The thickness of the coating should be sufficient to cover exposed fibers and fiber ends sealing them off from the environment. The thickness of the end coating 18 may range from about 0.001 inches to about 0.01 inches depending on the application.

The end coating 18 serves to encapsulate and seal the exposed fibers and fiber ends at the tape end 16. This is particularly beneficial in applications where the exposed fibers and fiber ends could interact with the environment, leading to degradation or contamination of the fibers. By sealing the exposed fibers and fiber ends, the end coating 18 helps to maintain the structural integrity and performance characteristics of the MMC tape 10.

In some aspects, the end coating 18 may comprise at least one of a metal, a metal alloy, a ceramic, or a polymer material. The choice of coating material may depend on the specific requirements of the application, the compatibility with the metal matrix 14 and the reinforcing fibers 12, and the desired properties of the end coating 18. For example, if the MMC tape 10 is used in a high-temperature environment, a ceramic or metal alloy coating may be used due to their excellent thermal stability. On the other hand, if the MMC tape 10 is used in a corrosive environment, a metal or metal alloy coating with good corrosion resistance may be preferred.

The end coating 18 may be applied using various techniques such as plasma vapor deposition or chemical vapor deposition (CVD) or spray coating. These techniques offer precise control over the coating thickness and composition, ensuring effective sealing of the exposed fibers and fiber ends. In some cases, the thickness “a” of the end coating 18 may be adjusted based on the specific requirements of the application. For example, a thicker coating may be applied for applications requiring higher levels of protection, while a thinner coating may be sufficient for less demanding applications.

In some embodiments, the forming step may comprise cutting an end of the MMC tape 10 to create the tape end 16. The cutting process may be performed using various techniques such as sawing, shearing, or laser cutting, depending on the specific requirements of the application. After the cutting process, the tape end 16 may have exposed ends of the reinforcing fibers 12, which are then sealed by the application of the end coating 18. This approach ensures that the exposed fibers and fiber ends are effectively sealed, preventing degradation and maintaining the structural integrity of the MMC tape 10.

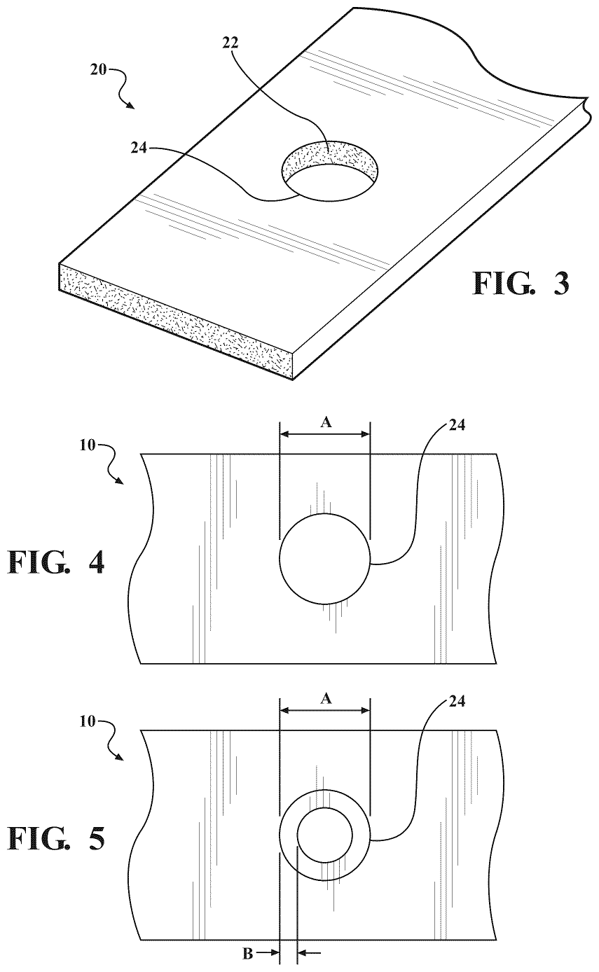

Referring to FIG. 3, a perspective view of a metal matrix composite (MMC) tape 20 with a hole 24 formed therein is illustrated. The MMC tape 20 is shown as a rectangular piece with a thickness. The hole 24 is visible on the upper surface of the MMC tape 20. Around the perimeter and internal walls of the hole 24 are exposed fibers 22. These exposed fibers 22 are the result of the hole formation process, which has cut through the reinforcing fibers embedded in the metal matrix of the MMC tape 20. The exposed fibers 22 may be small protrusions or irregularities around the edge of the hole 24, illustrating the need for a sealing process to cover and protect these exposed ends.

In some aspects, the hole 24 may be formed through the MMC tape 20 by various methods such as drilling, punching, or laser cutting. The hole 24 may be of any shape, such as circular, square, rectangular, or any other shape depending on the specific requirements of the application. The diameter or size of the hole 24 may also vary based on the application. For example, in some cases, the hole 24 may have a diameter ranging from about 0.1 inches to about 2 inches or larger.

The formation of the hole 24 through the MMC tape 20 results in at least one exposed surface where ends of the reinforcing fibers 22 are exposed. These exposed fibers 22 and fiber ends can be friable, breaking off into pieces, and may interact with the environment, leading to degradation or contamination of the fibers. Therefore, there is a need to seal off these exposed fibers 22 to prevent fiber degradation, friable pieces from coming off, and reduce exposure to certain environments.

Referring to FIG. 4, a top view of a metal matrix composite (MMC) tape 20 with a hole 24 formed therein is illustrated. The hole 24 is depicted as a circular opening in the MMC tape 10, positioned in the center of the image. The hole 24 has an initial hole diameter, labeled as “A” which represents the diameter of hole 24 before any further processing.

Referring to FIG. 5, a section view of a metal matrix composite (MMC) tape 20 with a hole 24 and coating 28 is illustrated. The MMC tape 20 is shown as a portion of a larger structure with a hole 24 formed through its thickness. The hole 24 has an initial diameter labeled as “A” at the top of the figure. The interior surface of the hole 24 is covered with a coating 28. This coating 28 is applied to the inner walls of the hole 24, reducing its diameter. The thickness of the coating 28 is indicated by dimension “B.”

The coating 28 is shown as a layer lining the interior of the hole 24. In some embodiments, the coating 28 may have a uniform thickness around the circumference of the hole 24. The coating 28 serves to seal off any exposed fibers or fiber ends that may have resulted from the hole formation process in the MMC tape 20.

In some aspects, the coating 28 may comprise at least one of a metal, a metal alloy, a ceramic, or a polymer material. The choice of coating material may depend on the specific requirements of the application, the compatibility with the metal matrix and the reinforcing fibers 22, and the desired properties of the coating 28. For example, if the MMC tape 20 is used in a high-temperature environment, a ceramic or metal alloy coating may be used due to their excellent thermal stability. On the other hand, if the MMC tape 20 is used in a corrosive environment, a metal or metal alloy coating with good corrosion resistance may be preferred.

The coating 28 may be applied using various techniques such as plasma vapor deposition, chemical vapor deposition (CVD) or spray coating, offering precise control over the coating thickness and composition. In some cases, the thickness “B” of the coating 28 may be adjusted based on the specific requirements of the application. For example, a thicker coating may be applied for applications requiring higher levels of protection, while a thinner coating may be sufficient for less demanding applications. The thickness of the coating 28 may range from about 0.001 inches to about 0.01 inches or greater depending on the application.

In some embodiments, a coating may be applied to the interior surface of the hole 24 to seal off the exposed fibers. The coating may be applied using various techniques such as plasma vapor deposition, chemical vapor deposition (CVD) or spray coating, offering precise control over the coating thickness and composition. The coating material may be similar or compatible with the metal matrix of the MMC tape 20. For example, if the MMC tape 20 comprises an aluminum matrix, the coating may comprise aluminum or an aluminum alloy. The coating effectively seals the exposed ends of the reinforcing fibers, providing protection against environmental factors and improving the overall performance of the MMC tape 20 in sensitive applications.

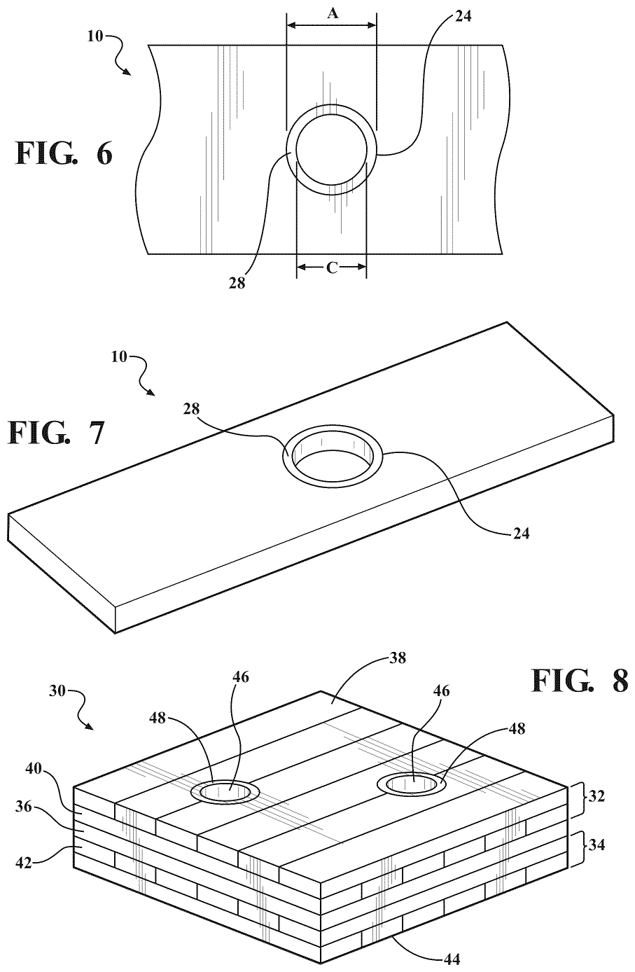

“Referring to FIG. 6, a top view of a portion of an MMC tape 20 with a hole 24 and coating 28 is illustrated. The coating 28 has been machined to provide a final diameter “C” for the hole 24. The figure shows the process of creating a precise hole diameter in the MMC tape 20 where an initial oversized hole having a initial hole diameter “A” was created as illustrated in FIG. 4, a coating 28 having a thickness “B” was applied to interior walls of the hole 24 as illustrated in FIG. 5, and then some of the coating 28 was removed to provide a final diameter “C” for the hole 24 as provided in FIG. 6.

The final diameter “C” of the hole 24 is smaller than the initial hole diameter “A” and is a result of machining the thickness of the coating to the desired final diameter “C”. Importantly, the remaining coating should be thick enough that substantially all of the exposed fibers and fiber ends resulting from the hole formation are covered. This approach ensures complete coverage of all exposed fibers while allowing for subsequent refinement of the hole size to achieve precise dimensions.

In some embodiments, the forming step may comprise creating an oversized hole through the MMC tape 10, applying the coating 28 to an interior surface of the oversized hole with a coating thickness sufficient to create a hole diameter smaller than a desired final diameter, and machining the coated hole to the desired final diameter. This process allows for precise control of the final hole dimensions while ensuring complete coverage of exposed fibers within the MMC tape 10.

In some aspects, the thickness “B” of the coating 28 may be adjusted based on the specific requirements of the application. For example, a thicker coating may be applied for applications requiring higher levels of protection, while a thinner coating may be sufficient for less demanding applications. The thickness of the coating 28 may range from about 0.001 inches to about 0.01 inches or greater depending on the application.

Referring to FIG. 7, a perspective view of a metal matrix composite (MMC) tape 20 with a hole 24 and coating 28 is illustrated. A circular hole 24 is formed through the MMC tape 20. The interior surface of the hole 24 is covered with a coating 28. The coating 28 lines the entire inner circumference of the hole 24, extending from the top surface to the bottom surface of the MMC tape 20. This coating 28 serves to seal off any exposed fibers or fiber ends that may have resulted from the hole formation process in the MMC tape 20.

Referring to FIG. 8, an isometric view of a composite structure 30 is illustrated. The composite structure 30 comprises a metal core 36 sandwiched between a first metal matrix composite (MMC) layer 32 and a second metal matrix composite (MMC) layer 34. The first MMC layer 32 is disposed on a first side of the metal core 36, while the second MMC layer 34 is disposed on a second side of the metal core 36, opposite the first side.

In some aspects, the metal core 36 may comprise at least one of aluminum, titanium, steel, or alloys thereof. The choice of material for the metal core 36 may depend on the specific requirements of the application, such as strength, weight, thermal conductivity, and corrosion resistance.

The first MMC layer 32 and the second MMC layer 34 each comprise a metal matrix and reinforcing fibers. The metal matrix may comprise at least one of aluminum, magnesium, titanium, copper, or alloys thereof, and the reinforcing fibers may comprise at least one of alumina, boron, silicon carbide, carbon, or glass fibers. In some cases, the metal matrix of the first MMC layer 32 and the second MMC layer 34 may be similar to the metal of the metal core 36.

The composite structure 30 further comprises at least one hole 46 extending through the first MMC layer 32, the metal core 36, and the second MMC layer 34. The hole 46 provides a pathway through the composite structure 30, allowing for the passage of gases, powders, or other materials.

The interior surface of the hole 46 is lined with a coating 48. The coating 48 extends continuously through the first MMC layer 32, the metal core 36, and the second MMC layer 34. In some embodiments the coating 48 only extends through the first MMC layer 32 and the second MMC layer 34. The coating 48 serves to seal the exposed ends of the reinforcing fibers in the hole 46 in the first MMC layer 32 and the second MMC layer 34. This sealing process is essential for maintaining the integrity of the composite structure 30 in applications where exposure of the fibers could lead to degradation or undesired interactions with the surrounding environment such as for reaction vessels or other applications where a reactive gas or material is being exposed to the composite structure.

In some embodiments, the coating 48 may comprise at least one of a metal, a metal alloy, a ceramic, or a polymer material. The choice of coating material may depend on the specific requirements of the application, the compatibility with the metal matrix and the reinforcing fibers, and the desired properties of the coating 48. For example, if the composite structure 30 is used in a high-temperature environment, a ceramic or metal alloy coating may be used due to their excellent thermal stability. On the other hand, if the composite structure 30 is used in a corrosive environment, a metal or metal alloy coating with good corrosion resistance may be preferred.

The coating 48 may be applied using various techniques such as plasma vapor deposition, chemical vapor deposition (CVD), or spray coating, offering precise control over the coating thickness and composition. In some cases, the thickness of the coating 48 may be adjusted based on the specific requirements of the application. For example, a thicker coating may be applied for applications requiring higher levels of protection, while a thinner coating may be sufficient for less demanding applications. The thickness of the coating 48 may range from about 0.001 inches to about 0.01 inches or greater depending on the application.

Continuing with the description of FIG. 8, the first MMC layer 32 and the second MMC layer 34 each comprise a metal matrix and reinforcing fibers. In some aspects, the metal matrix of the first MMC layer 32 and the second MMC layer 34 may comprise at least one of aluminum, magnesium, titanium, copper, or alloys thereof. The reinforcing fibers in the first MMC layer 32 and the second MMC layer 34 may comprise at least one of alumina, boron, silicon carbide, carbon, or glass fibers.

Each of the first MMC layer 32 and the second MMC layer 34 may comprise two or more layers of MMC tape oriented at different angles relative to each other. In some cases, the two or more layers of MMC tape in each of the first MMC layer 32 and the second MMC layer 34 may be oriented at 90 degrees relative to each other. This arrangement of the MMC tape layers at different angles relative to each other provides structural integrity to the composite structure 30.

The arrangement of the MMC tape layers at different angles relative to each other in the composite structure 30 provides several advantages. In some cases, the orientation of the MMC tape layers can enhance the structural integrity of the composite structure 30 by distributing the load more evenly across the structure. This can help to prevent localized stress concentrations, which can lead to premature failure of the structure.

In some embodiments, the first MMC layer 32 and the second MMC layer 34 each comprise two or more layers of MMC tape. These layers of MMC tape may be oriented at different angles relative to each other. For example, in some cases, the two or more layers of MMC tape in each of the first MMC layer 32 and the second MMC layer 34 may be oriented at 90 degrees relative to each other. This cross-ply arrangement can provide balanced mechanical properties in multiple directions, enhancing the overall performance of the composite structure 30.

In some embodiments, the first MMC layer 32 and the second MMC layer 34 may each comprise multiple layers of MMC tape. The first MMC layer 32 may include a first outer MMC tape layer 38 and a first inner MMC tape layer 40, while the second MMC layer 34 may include a second inner MMC tape layer 42 and a second outer MMC tape layer 44.

The first outer MMC tape layer 38 and the second outer MMC tape layer 44 may be positioned on the outermost surfaces of the composite structure 30. These outer layers may be designed to provide specific surface properties or to act as protective layers for the underlying structure. In some cases, the outer layers may have different compositions or fiber orientations compared to the inner layers to optimize surface characteristics or environmental resistance.

The first inner MMC tape layer 40 and the second inner MMC tape layer 42 may be positioned between the outer layers and the metal core 36. These inner layers may be engineered to provide additional strength, stiffness, or other mechanical properties to the composite structure. In some aspects, the inner layers may have higher fiber volume fractions or different fiber types compared to the outer layers to enhance the overall structural performance of the composite.

The orientation of the reinforcing fibers within each MMC tape layer may be tailored to meet specific design requirements. For instance, the first outer MMC tape layer 38 and the first inner MMC tape layer 40 may have their fibers oriented at different angles relative to each other. Similarly, the second inner MMC tape layer 42 and the second outer MMC tape layer 44 may also have different fiber orientations. This multi-directional arrangement of fibers can provide enhanced mechanical properties in various loading directions.

In some embodiments, the thickness of each MMC tape layer may be varied to optimize the overall performance of the composite structure 30. For example, the outer layers (38 and 44) may be thinner than the inner layers (40 and 42) to provide a balance between surface properties and structural strength. Alternatively, the layer thicknesses may be adjusted to control the overall thickness of the composite structure 30 or to fine-tune its mechanical response.

The composition of the metal matrix and the type of reinforcing fibers may be selected independently for each MMC tape layer. This allows for the creation of functionally graded materials, where the properties of the composite structure 30 vary through its thickness. For instance, the outer layers may incorporate fibers with higher corrosion resistance, while the inner layers may use fibers with superior strength or stiffness properties.

In some cases, additional MMC tape layers may be incorporated between the inner and outer layers to further customize the properties of the composite structure 30. These intermediate layers may have unique fiber orientations, compositions, or thicknesses to address specific design requirements or to provide gradual transitions in material properties through the thickness of the structure.

The arrangement of multiple MMC tape layers within the first MMC layer 32 and the second MMC layer 34 provides flexibility in designing composite structures with tailored properties. By varying the number, orientation, composition, and thickness of these layers, the mechanical, thermal, and environmental performance of the composite structure 30 may be optimized for specific applications.

In other embodiments, the layers of MMC tape in the first MMC layer 32 and the second MMC layer 34 may be oriented at other angles ranging from about 1 degree to about 89 degrees relative to each other. The specific angle of orientation may be selected based on the specific requirements of the application. For example, in applications requiring high strength in a particular direction, the layers of MMC tape may be oriented parallel to that direction. In contrast, in applications requiring balanced properties in multiple directions, the layers of MMC tape may be oriented at various angles to each other.

The ability to tailor the orientation of the MMC tape layers in the composite structure 30 provides a high degree of design flexibility, allowing engineers to optimize the structure for specific performance requirements. This versatility further broadens the potential applications of the composite structure 30.

In some embodiments, the MMC tape layers may be attached to one another and to the metal core using various bonding techniques. Adhesive bonding may be employed to join the MMC tape layers and the metal core. The adhesive may be selected based on its compatibility with the metal matrix and reinforcing fibers, as well as its ability to withstand the intended operating conditions of the composite structure. In some cases, a high-temperature adhesive may be used for applications involving elevated temperatures. [examples?]

Welding techniques may also be utilized to join the MMC tape layers and the metal core. In some aspects, fusion welding methods such as electron beam welding or laser welding may be employed to create strong, metallurgical bonds between the layers. These welding techniques may be particularly suitable when the metal matrix of the MMC tape layers is compatible with the metal core material.

Ultrasonic welding may be used in some embodiments to join the MMC tape layers and the metal core. This solid-state welding process may be advantageous for joining dissimilar materials or for applications where minimizing heat input is desirable. The ultrasonic welding process may create localized bonding between the layers without significantly altering the microstructure of the materials.

In some cases, a combination of bonding techniques may be employed. For example, adhesive bonding may be used to join the MMC tape layers to each other, while welding may be used to attach the MMC layers to the metal core. This hybrid approach may allow for optimization of the bonding process based on the specific materials and design requirements of the composite structure.

The selection of the bonding technique may depend on factors such as the materials being joined, the desired bond strength, the operating environment of the composite structure, and the manufacturing constraints. In some embodiments, the bonding process may be followed by a heat treatment or curing step to enhance the bond strength and overall performance of the composite structure.

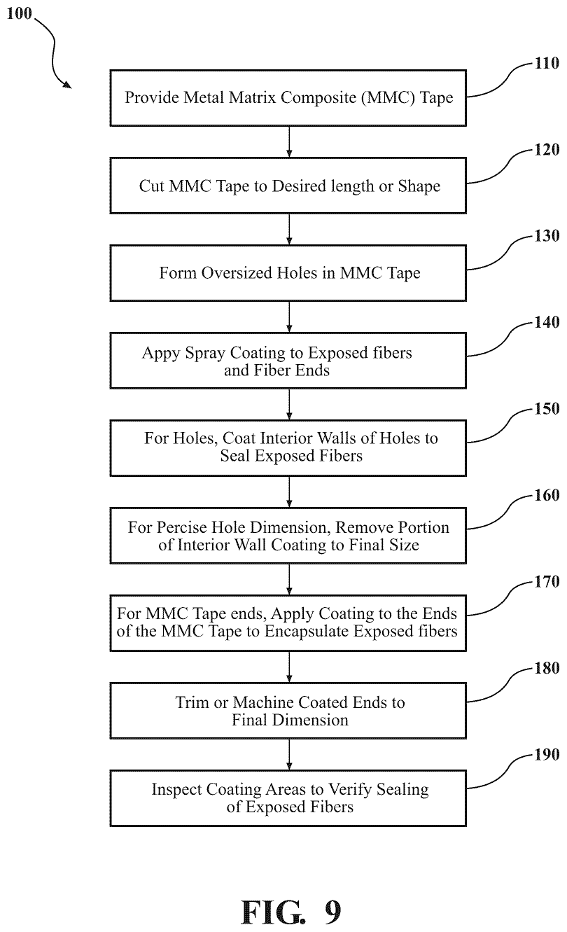

Referring to FIG. 9, a flowchart for a method 100 of preparing and coating metal matrix composite (MMC) tape to seal exposed fibers is illustrated. The method 100 begins with step 110, which involves providing the MMC tape. The MMC tape may be provided in various forms, such as a roll or coil of continuous tape, which can be cut to the desired length as needed. The MMC tape may have a thickness between about 0.01 inches and about 0.03 inches, and a width ranging from about 0.25 inches to about 6 inches.

The process then moves to step 120, where the MMC tape may be cut to the desired length or shape. This step may involve various cutting techniques such as sawing, shearing, or laser cutting, depending on the specific requirements of the application.

In step 130, oversized holes may be formed in the MMC tape if needed for the specific application. The holes may be of any shape, such as circular, square, rectangular, or any other shape depending on the requirements. The diameter or size of the hole may vary based on the application, potentially ranging from about 0.1 inches to about 2 inches or larger.

The method 100 then proceeds to step 140, where a coating may be applied to exposed fibers and fiber ends using techniques such as plasma vapor deposition, chemical vapor deposition (CVD), or spray coating. This coating effectively seals the exposed ends of the reinforcing fibers, providing protection against environmental factors and improving the overall performance of the MMC tape in sensitive applications.

Step 150 may involve coating the interior walls of any holes to seal exposed fibers. This step ensures that all exposed fibers, including those within formed holes, are properly sealed.

If precise hole dimensions are required, step 160 may include drilling or shaping the coated holes to their final size. This step allows for refinement of the hole dimensions while maintaining the protective coating on the exposed fibers.

In step 170, the tape ends may be coated with a metal material to encapsulate any exposed fibers. This step provides additional protection for the exposed fibers at the ends of the MMC tape.

Step 180 may involve trimming or machining the coated ends to achieve the final dimensions if needed. This step allows for precise control of the final MMC tape dimensions while maintaining the protective coating.

The final step in the method 100 is step 190, which may involve inspecting the coated areas to ensure that all exposed fibers are completely sealed. This inspection may involve visual inspection, microscopy, or other suitable techniques to verify the integrity of the coating and the complete coverage of the exposed fibers.

In some embodiments, the coating may be applied using chemical vapor deposition (CVD). The CVD process for coating the MMC tape may involve several steps to ensure effective sealing of exposed fibers and fiber ends.

The CVD process may begin by placing the MMC tape in a CVD chamber. The chamber may be designed to accommodate the dimensions of the MMC tape, including any holes or exposed surfaces that require coating. In some cases, multiple MMC tapes or components may be coated simultaneously within the chamber.

Once the MMC tape is positioned in the chamber, one or more precursor gases may be introduced. The choice of precursor gases depends on the desired coating material and may include organometallic compounds, metal halides, or other volatile metal-containing substances. For example, if an aluminum coating is desired, trimethylaluminum or aluminum chloride may be used as precursor gases.

After introducing the precursor gases, the CVD chamber may be heated to a deposition temperature. The specific temperature may vary depending on the precursor gases and desired coating properties, but may typically range from about 200° C. to 1000° C. In some cases, the temperature may be adjusted during the deposition process to control the coating's microstructure or composition.

The deposition temperature may be maintained for a predetermined time to allow the precursor gases to react and form the coating on the exposed surfaces of the MMC tape. This reaction may involve the decomposition or chemical transformation of the precursor gases, resulting in the deposition of the coating material. The duration of this step may range from a few minutes to several hours, depending on the desired coating thickness and deposition rate.

During the deposition process, the precursor gases may flow continuously through the chamber, ensuring a steady supply of coating material. In some embodiments, the gas flow rate and chamber pressure may be carefully controlled to optimize the coating uniformity and properties. The chamber pressure may typically range from about 0.1 to 100 Torr, depending on the specific CVD technique used.

To enhance coating uniformity, particularly for complex geometries such as hole interiors, the MMC tape may be rotated or repositioned within the chamber during deposition. This movement may help ensure that all exposed surfaces receive adequate coverage.

After the desired coating thickness is achieved, the CVD chamber may be cooled to room temperature. The cooling rate may be controlled to prevent thermal stress in the coating or the MMC tape. Once cooled, the coated MMC tape may be removed from the chamber.

In some cases, post-deposition treatments may be applied to further enhance the coating properties. These treatments may include annealing to improve coating adhesion or reduce internal stresses, or surface treatments to modify the coating's texture or chemical composition.

The CVD process offers several advantages for coating MMC tapes. It may provide excellent control over coating thickness and composition, allowing for the deposition of uniform and conformal coatings even on complex geometries such as hole interiors. The process may also produce high-purity coatings with strong adhesion to the substrate, which is crucial for effectively sealing exposed fibers and maintaining the MMC tape's performance in demanding applications.

In some embodiments, the coating may be applied to the MMC tape using plasma vapor deposition. The plasma vapor deposition process may involve several steps to ensure effective sealing of exposed fibers and fiber ends. The plasma vapor deposition process may begin by placing the MMC tape in a plasma vapor deposition chamber. The chamber may be designed to accommodate the dimensions of the MMC tape, including any holes or exposed surfaces that require coating. In some cases, multiple MMC tapes or components may be coated simultaneously within the chamber.

Once the MMC tape is positioned in the chamber, a process gas may be introduced. The choice of process gas may depend on the desired coating material and properties. For example, argon may be used as an inert carrier gas, while reactive gases such as oxygen or nitrogen may be introduced to form oxide or nitride coatings.

After introducing the process gas, plasma may be generated within the chamber. This may be achieved by applying an electric field to ionize the gas, creating a mixture of ions, electrons, and neutral species. The plasma may be generated using various methods, such as radio frequency (RF) power, direct current (DC) power, or microwave energy. In some aspects, a coating material may be introduced into the plasma. This may be accomplished by various means, such as sputtering a target material, evaporating a source material, or introducing precursor gases. The choice of coating material introduction method may depend on the specific coating material and desired properties.

The energetic species in the plasma may then interact with the coating material, causing it to deposit onto the exposed surfaces of the MMC tape. The plasma may provide energy for chemical reactions, enhance surface mobility of deposited species, and promote adhesion of the coating to the substrate. To ensure uniform coating coverage, the plasma containing the coating material may be directed towards the exposed surfaces of the MMC tape. This may be achieved through the use of magnetic fields, substrate bias, or geometric arrangements within the deposition chamber.

The plasma vapor deposition process may be maintained for a predetermined time to form the coating on the exposed surfaces. The duration of the deposition process may depend on factors such as the desired coating thickness, deposition rate, and coating material properties. In some embodiments, the substrate temperature may be controlled during the plasma vapor deposition process. Heating or cooling the MMC tape may influence coating properties such as density, crystallinity, or residual stress. The temperature may be adjusted using substrate holders with heating or cooling capabilities.

After the desired coating thickness is achieved, the plasma may be extinguished, and the chamber may be allowed to cool. The coated MMC tape may then be removed from the chamber for further processing or inspection. In some cases, post-deposition treatments may be applied to enhance the coating properties. These treatments may include annealing to improve coating adhesion, reduce internal stresses, or modify the coating's microstructure.

The plasma vapor deposition process may offer several advantages for coating MMC tapes. It may provide excellent control over coating composition and microstructure, allowing for the deposition of dense and adherent coatings. The process may also be suitable for coating complex geometries, such as hole interiors, due to the ability of the plasma to penetrate into small features.

In some embodiments, the coating may be applied to the MMC tape using spray coating techniques such as thermal spray, arc spray, high velocity oxygen fuel (HVOF) spray, powder coating or other spray coating techniques. The spray coating process may offer several advantages for coating MMC tapes, including the ability to deposit coatings at relatively low temperatures, which may help preserve the properties of the substrate material.

The spray coating deposition process may begin by placing the MMC tape in a spray coating chamber or positioning it in front of a spray coating nozzle. The chamber or nozzle may be designed to accommodate the dimensions of the MMC tape, including any holes or exposed surfaces that require coating. In some cases, multiple MMC tapes or components may be coated simultaneously or in sequence.

Once the MMC tape is positioned, a carrier gas may be introduced into the spray coating system. The carrier gas may typically be helium or nitrogen, chosen based on factors such as cost, availability, and desired particle velocity. The carrier gas may be heated to temperatures ranging from about 100° C. to 1000° C., depending on the specific application and materials used.

In some aspects, coating material in the form of fine powder particles may be introduced into the heated carrier gas stream. The powder particles may have diameters ranging from about 5 to 100 micrometers. The choice of powder material may depend on the desired coating properties and may include metals, alloys, or in some cases, ceramics or polymers that are compatible with the spray coating process.

The mixture of heated carrier gas and powder particles may then be accelerated through a de Laval nozzle, which may increase the gas velocity to supersonic speeds. As the particles exit the nozzle, they may impact the surface of the MMC tape at high velocities, typically ranging from about 300 to 1200 meters per second. Upon impact, the high kinetic energy of the particles may cause them to deform plastically and bond to the substrate and to each other, forming a dense coating. This process may be referred to as kinetic spraying or solid-state deposition. The coating may build up layer by layer as multiple particles impact and bond to the surface.

To ensure uniform coating coverage, the spray coating nozzle or the MMC tape may be moved relative to each other. This movement may be achieved through the use of robotic arms, linear stages, or rotational fixtures. In some embodiments, computer-controlled systems may be used to precisely control the movement and achieve complex coating patterns or uniform coverage on intricate geometries. The spray coating process may be maintained for a predetermined time to form the coating on the exposed surfaces. The duration of the deposition process may depend on factors such as the desired coating thickness, deposition efficiency, and the size of the area to be coated.

In some embodiments, the substrate temperature may be controlled during the spray coating process. While the process is generally considered “cold” compared to other thermal spray techniques, the impact of particles and the use of heated carrier gas may cause some heating of the substrate. Cooling systems may be employed to maintain the substrate temperature within desired limits.

After the desired coating thickness is achieved, the spray coating process may be terminated, and the coated MMC tape may be removed from the chamber or spray area. In some cases, post-deposition treatments may be applied to enhance the coating properties. These treatments may include annealing to reduce residual stresses or improve bonding between the coating and substrate.

The spray coating process may offer several advantages for coating MMC tapes. It may allow for the deposition of dense coatings with low oxidation and low residual stresses. The relatively low process temperatures may help preserve the microstructure and properties of the substrate material. Additionally, the spray coating process may be suitable for coating complex geometries, including hole interiors, due to the directionality of the particle stream and the ability to manipulate the spray nozzle or substrate position.

While chemical vapor deposition, plasma vapor deposition, and spray coating have been described, other method for applying a coating on a surface may be used as well provided they are able to effectively coat the exposed fiber and fiber ends of the MMC tape and seal them from the environment. Other methods may include, but are not limited to, plasma spray, wire arc spray, electrodeposition, and powder coating. Polymers may be applied by painting or applying the polymer to the exposed fibers and fiber ends.

In some aspects, the metal matrix of the MMC tape may comprise a variety of materials. For instance, the metal matrix may include, but is not limited to, aluminum, magnesium, silver, gold, platinum, copper, palladium, zinc, or alloys and combinations thereof. The choice of the metal matrix material may depend on the specific requirements of the application, such as strength, weight, thermal conductivity, and corrosion resistance. For example, aluminum may be chosen for its low density and excellent thermal and electrical conductivity, making it suitable for lightweight applications requiring good heat dissipation. On the other hand, gold or platinum may be used in high-end electronic and aerospace applications where corrosion resistance and conductivity are crucial.

The reinforcing fibers embedded within the metal matrix of the MMC tape may also comprise a variety of materials. These fibers may include, but are not limited to, carbon fibers, boron fibers, silicon carbide fibers, aluminum oxide fibers, glass fibers, quartz fibers, basalt fibers, ceramic fibers, metal fibers, or combinations thereof. The selection of fibers may depend on the desired characteristics and the compatibility with the metal matrix. For instance, carbon fibers, known for their high strength-to-weight ratio and excellent stiffness, are widely used in aerospace and high-performance applications. Boron fibers, offering exceptional stiffness and compressive strength, are suitable for applications requiring high dimensional stability. Silicon carbide fibers, characterized by high temperature resistance and good thermal conductivity, are often used in high-temperature applications. The reinforcing fibers should be compatible and with the metal of the metal matrix such that the fibers or the metal does not significantly react with one another or degrade significantly.

The coating applied to the at least one exposed surface of the MMC tape may comprise a variety of materials. The coating may include, but is not limited to, a metal, a metal alloy, a ceramic, or a polymer material. The choice of coating material may depend on the specific requirements of the application, the compatibility with the metal matrix and the reinforcing fibers, and the desired properties of the coating. For example, if the MMC tape 10 is used in a high-temperature environment, a ceramic or metal alloy coating may be used due to their excellent thermal stability. On the other hand, if the MMC tape 10 is used in a corrosive environment, a metal or metal alloy coating with good corrosion resistance may be preferred. In some cases, the coating material may be similar or compatible with the metal matrix of the MMC tape 10. For example, if the MMC tape 10 comprises an aluminum matrix, the coating may comprise aluminum or an aluminum alloy.

In some embodiments, the coating applied to the exposed surfaces of the MMC tape may comprise various metals or metal alloys. The choice of metal for the coating may depend on factors such as compatibility with the metal matrix, desired properties, and specific application requirements. Some metals that may be used for the coating include aluminum, titanium, nickel, copper, silver, gold, platinum, palladium, chromium, cobalt, zinc, tin, lead, indium, magnesium, manganese, iron, molybdenum, tungsten, tantalum, or alloys thereof.

In some cases, alloys of these metals may be used to tailor the coating properties. For example, nickel-chromium alloys may be used for improved corrosion resistance, while aluminum-copper alloys may provide enhanced strength and conductivity. The specific metal or alloy composition may be selected based on the intended operating environment and performance requirements of the MMC tape.

In some embodiments, the coating applied to the exposed surfaces of the MMC tape may comprise various ceramic materials. Ceramic coatings may be selected for their excellent thermal stability, wear resistance, and chemical inertness. Some ceramic materials that may be used for the coating include aluminum oxide (alumina), silicon carbide, titanium nitride, zirconium oxide (zirconia), boron nitride, silicon nitride, titanium carbide, chromium oxide, or combinations thereof.

In some cases, aluminum oxide (alumina) may be used as a coating material due to its high hardness, excellent wear resistance, and good thermal stability. Silicon carbide coatings may be applied in applications requiring high temperature resistance and good thermal conductivity. Titanium nitride coatings may be utilized for their excellent hardness and low friction properties, which can be beneficial in wear-resistant applications.

Zirconium oxide (zirconia) coatings may be employed in applications requiring high temperature resistance and low thermal conductivity. Boron nitride coatings may be used in applications where electrical insulation and thermal conductivity are desired. Silicon nitride coatings may be applied for their high strength, toughness, and thermal shock resistance.

In some aspects, composite ceramic coatings may be used to combine the beneficial properties of multiple ceramic materials. For example, a coating comprising a mixture of aluminum oxide and titanium nitride may provide both high hardness and low friction properties. The specific ceramic composition may be selected based on the intended operating environment, desired properties, and compatibility with the metal matrix and reinforcing fibers of the MMC tape.

In some embodiments, the coating applied to the exposed surfaces of the MMC tape may comprise various polymer materials. Polymer coatings may be selected for their versatility, ease of application, and ability to provide specific properties such as chemical resistance, electrical insulation, or improved surface finish. Some polymer materials that may be used for the coating include thermoplastics, thermosets, and elastomers.

Thermoplastic polymers that may be used for coating include polyethylene (PE), polypropylene (PP), polyvinyl chloride (PVC), polyethylene terephthalate (PET), polyamides (nylon), polycarbonates (PC), polyether ether ketone (PEEK), and fluoropolymers such as polytetrafluoroethylene (PTFE). These materials may offer advantages such as good chemical resistance, low friction, and ease of processing.

Thermoset polymers that may be used for coating include epoxy resins, polyurethanes, phenolic resins, and silicones. These materials may provide excellent adhesion, high temperature resistance, and good electrical insulation properties. In some cases, epoxy coatings may be used for their high strength and excellent chemical resistance, while polyurethane coatings may be applied for their flexibility and abrasion resistance.

Elastomeric polymers that may be used for coating include natural rubber, synthetic rubbers such as styrene-butadiene rubber (SBR), nitrile rubber (NBR), and silicone rubber. These materials may offer advantages such as flexibility, impact resistance, and vibration damping.

In some aspects, fluoropolymer coatings such as PTFE may be used for their excellent non-stick properties, chemical resistance, and low friction characteristics. These coatings may be particularly useful in applications where reduced friction or easy release properties are desired.

Conductive polymer coatings, such as polyaniline or polypyrrole, may be used in applications where electrical conductivity is required while maintaining the advantages of a polymer coating. These materials may provide a balance between the electrical properties of metals and the processing advantages of polymers.

In some cases, polymer nanocomposite coatings may be used to enhance specific properties of the coating. For example, incorporating nanoparticles of ceramics or metals into a polymer matrix may improve the coating's mechanical strength, thermal stability, or barrier properties.

UV-curable polymer coatings may be applied in some embodiments, allowing for rapid curing and reduced processing time. These coatings may include acrylate-based polymers that cure quickly upon exposure to ultraviolet light, providing a durable and chemically resistant surface.

The selection of the specific polymer coating may depend on factors such as the intended operating environment, desired surface properties, compatibility with the metal matrix and reinforcing fibers, and processing requirements. In some cases, a combination of different polymer materials may be used to achieve a balance of properties tailored to the specific application of the MMC tape.

In some embodiments, the metal matrix, the reinforcing fibers, and the coating may be selected independently based on the specific requirements of the application. This flexibility allows for the creation of MMC tapes with tailored properties, further broadening the potential applications of MMC tapes in advanced engineering fields.

In some aspects, the MMC tape may have dimensions that vary widely depending on the specific application and requirements. The width of the MMC tape is not particularly limited and may be selected based on the desired application. Typical ranges for the width of MMC tape may include from about 0.5 inches to 2 inches or larger. Similarly, the thickness of the MMC tape is not particularly limited. Typical thickness of MMC tape may range from about 0.010 inches to about 0.030 inches thick, and preferably about 0.015 inches thick.

The cross-sectional shape of the MMC tape is not particularly limited but preferably includes relatively flat sides that may be abutted against flat sides of adjacent pieces of MMC tape. Suitable cross-sectional shapes may include regular or irregular polygons, including but not limited to, a regular triangle, an acute triangle, a right triangle, an obtuse triangle, a parallelogram, a square, a rectangle, a trapezium, a kite, a rhombus, a pentagon, a hexagon, a heptagon, an octagon, a nonagon, a decagon, or other quadrilateral. In certain embodiments, the MMC tape may have a rectangular cross section.

In other cases, the MMC tape may have a cross-sectional shape that is tailored to the specific requirements of the application. For example, in applications where the MMC tape is used to form a curved structure, the cross-sectional shape may be a trapezium or a kite to facilitate the formation of the curved structure. In applications where the MMC tape is used to form a structure with sharp corners, the cross-sectional shape may be a square or a rectangle.

The ability to vary the dimensions and cross-sectional shape of the MMC tape provides a high degree of design flexibility, allowing engineers to optimize the MMC tape for specific performance requirements. This versatility further broadens the potential applications of MMC tape in advanced engineering fields.

A number of implementations have been described. Nevertheless, it will be understood that various modifications may be made without departing from the spirit and scope of the disclosure. Accordingly, other implementations are within the scope of the following claims.

What is claimed is:

1. A metal matrix composite (MMC) tape, comprising:
a plurality of reinforcing fibers embedded within a metal matrix;
at least one exposed surface where ends of the reinforcing fibers are exposed; and
a coating applied to the at least one exposed surface, wherein the coating seals the exposed ends of the reinforcing fibers.

2. The MMC tape of claim 1, wherein the coating is applied to at least one end of the MMC tape, sealing exposed ends of the reinforcing fibers at the at least one end.

3. The MMC tape of claim 1, further comprising a hole formed through the MMC tape, wherein the coating is applied to an interior surface of the hole to seal exposed ends of the reinforcing fibers within the hole.

4. The MMC tape of claim 1, wherein the metal matrix comprises aluminum and the reinforcing fibers comprise alumina fibers.

5. The MMC tape of claim 1, wherein the metal matrix comprises at least one of aluminum, magnesium, titanium, copper, or alloys thereof, and the reinforcing fibers comprise at least one of alumina, boron, silicon carbide, carbon, or glass fibers.

6. The MMC tape of claim 1, wherein the coating comprises at least one of a metal, a metal alloy, a ceramic, or a polymer material.

7. The MMC tape of claim 1, wherein the MMC tape has a thickness between about 0.01 inches and about 0.03 inches.

8. A method of preparing a metal matrix composite (MMC) tape, comprising:
providing an MMC tape comprising a plurality of reinforcing fibers embedded within a metal matrix;
forming at least one exposed surface on the MMC tape where ends of the reinforcing fibers are exposed; and
applying a coating to the at least one exposed surface, wherein the coating seals the exposed ends of the reinforcing fibers.

9. The method of claim 8, where in the forming step comprises cutting an end of the MMC tape.

10. The method of claim 8, wherein the forming step comprises creating a hole through the MMC tape.

11. The method of claim 8, wherein applying the coating comprises using at least one of plasma vapor deposition or chemical vapor deposition (CVD) or spray coating.

12. The method of claim 11, wherein applying the coating using chemical vapor deposition (CVD) comprises:
placing the MMC tape in a CVD chamber;
introducing one or more precursor gases into the CVD chamber;
heating the CVD chamber to a deposition temperature;
maintaining the deposition temperature for a predetermined time to allow the precursor gases to react and form the coating on the at least one exposed surface; and
cooling the CVD chamber and removing the coated MMC tape.

13. The method of claim 11, wherein applying the coating using plasma vapor deposition comprises:
placing the MMC tape in a plasma vapor deposition chamber;
introducing a process gas into the plasma vapor deposition chamber;
generating a plasma from the process gas;
introducing a coating material into the plasma;
directing the plasma containing the coating material towards the at least one exposed surface of the MMC tape; and
maintaining the plasma vapor deposition process for a predetermined time to form the coating on the at least one exposed surface.

14. The method of claim 11, wherein applying the coating using spray coating comprises:
placing the MMC tape in a spray coating chamber or positioning it in front of a spray coating nozzle;
introducing a carrier gas into a spray coating system;
heating the carrier gas to a temperature between about 100° C. to 1000° C.;
introducing coating material in the form of fine powder particles into the heated carrier gas stream;
accelerating the mixture of heated carrier gas and powder particles through a de Laval nozzle to supersonic speeds;
directing the accelerated powder particles towards the at least one exposed surface of the MMC tape; and
maintaining the spray coating process for a predetermined time to form the coating on the at least one exposed surface.

15. The method of claim 8, wherein the metal matrix comprises aluminum, the reinforcing fibers comprise alumina fibers, and the coating comprises aluminum.

16. The method of claim 8, wherein the forming step comprises:
creating an oversized hole through the MMC tape;
applying the coating to an interior surface of the oversized hole with a coating thickness sufficient to create a hole diameter smaller than a desired final diameter; and
machining the coated hole to the desired final diameter.

17. A composite structure, comprising:
a metal core;
a first metal matrix composite (MMC) layer disposed on a first side of the metal core;
a second metal matrix composite (MMC) layer disposed on a second side of the metal core opposite the first side;
at least one hole extending through the first MMC layer, the metal core, and the second MMC layer; and
a coating applied to an interior surface of the at least one hole, wherein the coating extends continuously through the first MMC layer and the second MMC layer wherein the coating seals the exposed ends of the reinforcing fibers in the at least one hole in the first MMC layer and the second MMC layer.

18. The composite structure of claim 17, wherein:
the first and second MMC layers comprise a metal matrix of at least one of aluminum, magnesium, titanium, copper, or alloys thereof, and reinforcing fibers of at least one of alumina, boron, silicon carbide, carbon, or glass fibers;
the metal core comprises at least one of aluminum, titanium, steel, or alloys thereof; and
the coating comprises at least one of a metal, a metal alloy, a ceramic, or a polymer material.

19. The composite structure of claim 17, wherein:
the first and second MMC layers comprise a metal matrix of aluminum and reinforcing fibers of alumina;
the metal core comprises aluminum; and
the coating comprises aluminum.

20. The composite structure of claim 17, wherein each of the first MMC layer and the second MMC layer comprises two or more layers of MMC tape oriented at different angles relative to each other.

21. The composite structure of claim 20, wherein the two or more layers of MMC tape in each of the first MMC layer and the second MMC layer are oriented at 90 degrees relative to each other.
